(19) United States
(12) Patent Application Publication
(10) Pub. No.: US 2004/0034647 A1
(43) Pub. Date: Feb. 19, 2004

(54) Archiving method and apparatus for digital information from web pages

(75) Inventors: K. Bradley Paxton, Webster, NY (US); Umar Riaz, Webster, NY (US)

Correspondence Address: Stephen B. Salai, Esq., Harter, Secrest & Emery LLP, 1600 Bausch & Lomb Place, Rochester, NY, 14604-2711, US

(73) Assignee: AKSA-SDS, Inc., Rochester, NY

(21) Appl. No.: 10/141,403

(22) Filed: May 8, 2002

(51) Int. Cl. G06F 17/30

(52) U.S. Cl. 707/102

(57) ABSTRACT

The present invention is a method for archiving data stored in a plurality of linked web pages, including traversing the plurality of web pages by recursively following the links to identify each of the individual web pages to be archived; making a list of web pages to be archived; sequentially retrieving the contents of each web page on the list; forming a digital image of the visible content of each web page; and ultimately creating a visually perceptible archival copy of each web page from the digital image on a durable, human readable medium.

### FIELD OF THE INVENTION

This invention relates generally to the archiving of information and more particularly to a method and apparatus for archiving digital information and more particularly information in the form of web pages.

### BACKGROUND OF THE INVENTION

In an information age archiving of information including digital information is extremely important. It has long been known how to archive information in a digital form on a variety of available media, including rigid and floppy magnetic disks, tapes, optical media and similar formats. Each of these media formats has some advantages and can be useful for short-term storage, but all suffer from one or more disadvantages. Many of these media formats are physically fragile and not suited for long term storage. Most of these media formats are recorder specific, meaning that they have no human readable bootstrap information to allow the information recorded to be decoded, decrypted or decompressed without specific knowledge of the recording manner in which the information was recorded.

Hardware for reading and writing recorder specific media changes frequently and often becomes obsolete and unavailable at the time the archived information needs to be retrieved. Even if the hardware used to record and recover the recorder specific media are available software drivers and applications as well as operating systems used to create the media may be unavailable. With technology changing as quickly as we have seen, major changes in technology occur that makes reader specific media not only obsolete but also make the information stored on such media unrecoverable. Consider for example, 8-inch floppy disks. For were only recently a standard recording media. Today it is virtually impossible to recover data from 8-inch floppy disks because 8-inch floppy disk readers are no longer available today.

In the last 5 years, the worldwide web has become very popular. Many millions of web pages have been created and put on line, to provide information, or in some cases, more recently, to transact business over the Internet. In most cases, a language like HTML (HyperText Markup Language) is written to describe the web pages and is interpreted by software “browsers”, such as Netscape. Most of the earliest web pages are already lost to the world because no one archived them. Given the large number of business-to-business transactions now coming on line, there is a need to easily archive web pages for posterity.

One approach to long-term archiving of digital information is to periodically migrate the stored digital information to a current media format based on the current recording technology. This is effective as long as the current recording technology is in use at the time when the recorded information is to be retrieved. If the recording technology is no longer available, then it is necessary to convert the stored information to a new format, test the process and re-record the information so that it can be retrieved at a later late. At the rate of current technology changes, as has been seen in the computer industry, this conversion to new stored data formats must occur every few years. This is both costly and risky for businesses because it introduces potential errors and exposes the stored data to alteration or deletion.

There is a need for a method and apparatus for archiving digital data that produces a substantially unalterable secure image, especially data stored in the form of web pages, that overcomes the limitations of the current methods. There is a need for method and apparatus for archiving digital information that allows low cost storage and retrieval that is convenient, allows multi-user access, is simple to read and write, and produces a long-life recording that does not need to be translated to other media formats in a year or two.

### SUMMARY OF THE INVENTION

The present invention is a method for archiving data stored in a plurality of linked web pages, including traversing the plurality of web pages by recursively following the links to identify each of the individual web pages to be archived; making a list of web pages to be archived; sequentially retrieving the contents of each web page on the list; forming a digital image of the visible content of each web page; and ultimately creating a visually perceptible archival copy of each web page from the digital image on a durable, human readable medium.

### BRIEF DESCRIPTION OF THE DRAWINGS

FIG. 1 depicts various linked web pages with various indicia.

FIG. 2 depicts a functional block diagram of the present invention.

FIG. 3 depicts a functional block diagram of the present invention.

FIG. 4 depicts a functional block diagram of the present invention.

FIG. 5 depicts a functional block diagram of the present invention.

### DETAILED DESCRIPTION OF THE PREFERRED EMBODIMENT

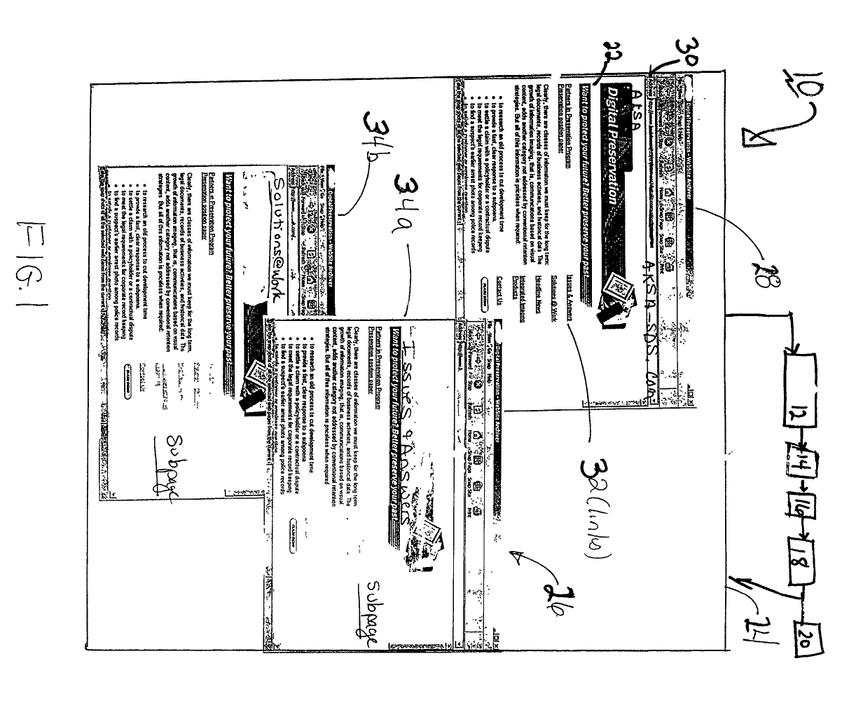

In the present invention a digital web site archiver, 10 as shown in FIG. 1, that archives digital information from a web site using specially-designed software 12 that will work with a readily available writing device 14, such as Eastman Kodak Company's Document Archive Writer, that allow the user to write electronic images (such as a TIFF file) to a storage media 16, such as microfilm, for archival storage and later use a reading device 18 to make the digital image available to a viewer 20. When a web page is identified that is to be archived, the program converts that electronic image to a suitable image format such as a TIFF, and places this file along with a unique identifier in a folder for subsequent archiving. Proceeding in this way, a web site may be understood and prepared for archival storage.

The web site digital archiver 10 includes the software program 12 for archiving data that is in a digital format 22 (data) in a computer 24. The software program 12 accepts a web site address (such as www.aksa-sds.com) as an input, along with other parameters to be described below relating generally to the quality and quantity of the archived record or data 22, The data 22 can be in the form of text such as HTML text, graphics or other digital data formats. The data 22 is often stored in the computer 24 as a plurality of linked web pages 26. The web site digital archiver 10 locates a first web page 28 that is of interest to the user and identifies an address 30, such as www.aksa-sds.com, associated with the web page 28. The web site digital archiver 10 transverses the first web page 28 by recursively following the links 32 to identify linked individual web pages 34A, 34B as shown in FIG. 1.

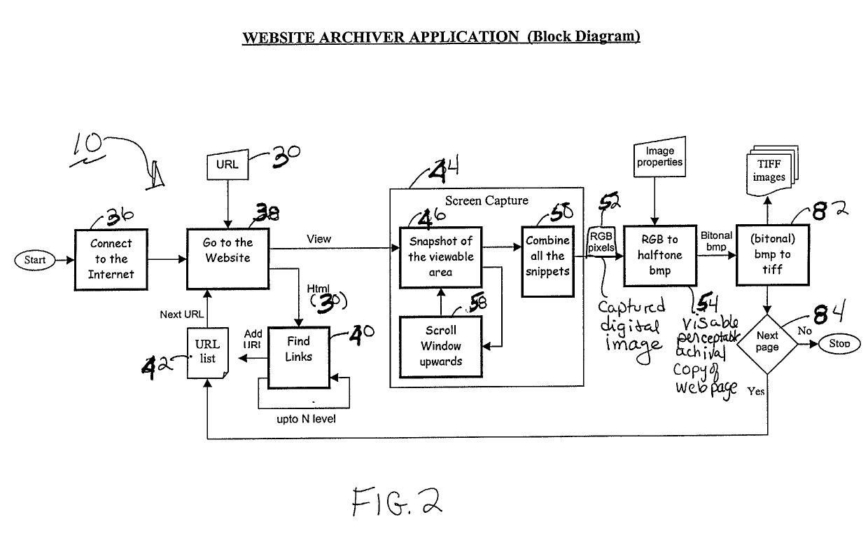

As shown in FIG. 2, after the web site digital archiver 10 has connected to the internet through an internet portal 36, it goes to a web site 38 and identifies address 30, hereafter referred to as an URL address 30 on the first web page 28 of interest. The internet portal 36 uses internet web browser technology and is a set of web browser interfaces. The web site digital archiver 10 recursively follows links on the first web page 28 to identify each of the individual web pages which are linked to the first web page 28. These directly linked individual web pages 34A, 34B are often called native links 34A, 34B and the web site archiver 10 can also find related links that are one or more links away, called non-native links 39 through the software that performs the Find Links operation 40. The web site digital archiver 10 then makes a list of these web pages to be archived 42. In the present invention the FindLinks operation 40 is a portion of the archiving software 12.

The web site digital archiver 10 sequentially retrieves the contents of each web page archived on the list by doing what is called a capture of the web page snapshot 44. The web page snapshot 44 capture involves three major steps. First, a snapshot of a viewable web page area 46 is taken and then an extended view of the website window can be viewed through the computer screen by scrolling up and down 48 to capture additional portions or snippets of the web site that are not viewable in the screen of the computer. Finally, the web site digital archiver 10 combines all the snippets or portions of a web page 50 to make the complete web page snapshot 44. This capturing step will be described later in more detail.

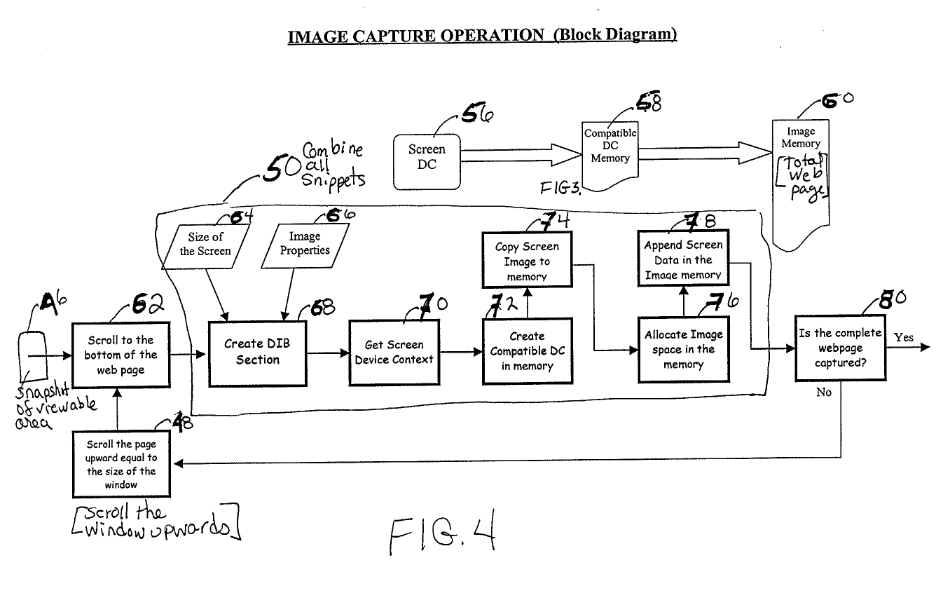

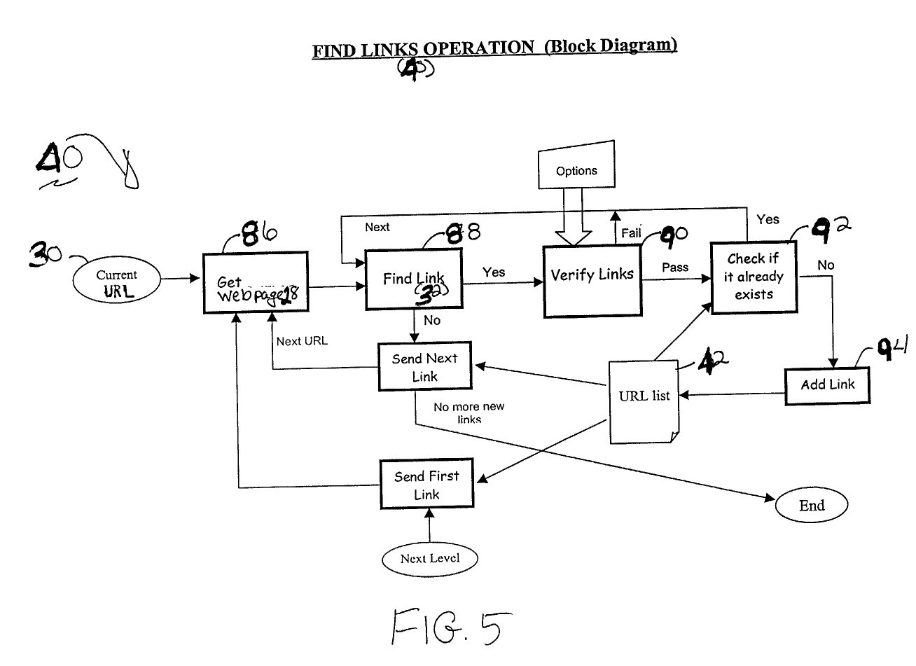

The web site digital archiver 10 takes the digital contents of each web page 34, usually the visible portions, to form a visible digital image 52 and then to create a visibly perceptible archive copy 54 of the digital image 52 from the web page that was captured in the web page snapshot 44. FIG. 3 shows a viewable screen display 56. The web site digital archiver 10 must be capable in the screen capture step 44 of capturing all of the data 22 on one or more linked web pages 28, including both native links 34 and non-native links 39. As shown in FIG. 3, when there is an elongated page 58, on which there is often more data 22 than is viewable in the viewable screen display 56, the data 22 to be accessed is not accessible to be captured with out the help of the web site digital archiver 10. The web site digital archiver 10 is capable of capturing a complete web page, including that information that is on the extended portion of the screen, viewable only by scrolling down using the scroll bars on the side of a web page, as shown in 58 using the Image Capture Operation portion of the software 12. The web site digital archiver 10 proceeds by storing all the data 22, including the additional information, as an image memory and combining it with the original screen display 56 for a total web image 60. This process is described below in more detain in conjunction with FIG. 4.

As shown in FIG. 4, the web site digital archiver 10 completes the web page snapshot capture 44 step by first taking a snapshot of the viewable area 46, as is shown in FIG. 3 as the screen display 56, and then scrolling to the bottom of the web page in step 62 before combining all the snippets of information on the web page 50. The web site digital archiver 10 first identifies the size of a screen display 56 in step 64 and various image properties 66 to create a DIB section in step 68. Then, the web site digital archiver 10 gets the screen device context in step 70 and creates compatible device context in the memory in step 72. The web site digital archiver 10 copies the screen image to memory in step 74 and allocates image space in the memory in step 76 before appending the screen data in the image memory in step 78. The web site digital archiver 10 then checks to see if the complete web site has been captured in step 80 and, if not, scrolls the page upward equal to size of the window 48 and then scrolls to the bottom of the web page as shown in step 62 before continuing to combine all the snippets as described above, resulting in a capture of all the data 22 on the web page. These steps continue until all the web pages on the URL list have been captured. The web site digital archiver 10 is designed to capture all the digital data on the related computer screens whether it is visible or not at an instant. The digital information that can be captured includes indicia such as alphanumeric characters, graphics and metatag information and other digital information that may not be visible to the user.

After the web page snapshot 44 capture has occurred, the captured digital data image is archived as the visibly perceptive copy of the web page 54 and is put in a TIFF file as already discussed above. The stored TIFF file can be in a range of formats including color, gray, bi-tone and halftone depending on the properties of the captured data, storage apparatus and method and anticipated user requirements.

FIG. 5 is a block diagram showing the FindLinks operation 40. As discussed above, the current URL 30 is used to access the web page of interest 28 shown in FIG. 5 as step 86. Next, the web site digital archiver 10 locates the related web sites and associated links to pages 32, both the native links 34 and the non-native links 39 as shown in step 88. The digital archiver 10 verifies that these links are viable links in step 90 and then checks if that link has already been added in step 92. If the link has not been added, then the link is added to the URL list 42 in step 94. If the link already exists, then the Find Links Operation 40 then proceeds to first find another native link 34 on web page 28. After all the native links 34 desired are added to the URL list 42 then the FindLinks Operation software checks for additional non-native links 39 until there are no more associated links. During the whole process, the Find links Operation 40 allows the user to interact directly with the software 12 to direct the extent of the search and also to direct what links are to be stored.

While the invention has been described with reference to preferred embodiments, those familiar with the art will understand that various changes may be made without departing from the scope of the invention. In addition, many modifications may be made to adapt a particular situation to the teachings of the invention without departing from the scope of the invention. Therefore, it is intended that the invention not be limited to the particular embodiments disclosed as the best mode contemplated for carrying out this invention, but that the invention will include all embodiments falling within the scope and spirit of the appending claims.

What is claimed:

1. A method for archiving data stored in a plurality of linked web pages, comprising:
traversing the plurality of web pages by recursively following the links to identify each of the individual web pages to be archived;
making a list of web pages to be archived;
sequentially retrieving the contents of each web page on the list;
forming a digital image of the visible content of each web page; and
creating a visually perceptible archival copy of each web page from the digital image on a durable, readable medium.

2. The method for archiving data stored in a plurality of linked web pages of claim 1 in which the step of making a list of web pages to be archived comprises making a list of the URL's of the pages to be archived.

3. The method for archiving data stored in a plurality of linked web pages of claim 1 in which making a list of web pages to be archived comprises selecting individual web pages from the identified web pages.

4. The method for archiving data stored in a plurality of linked web pages of claim 1 in which making a list of web pages to be archived comprises adding an unique identifier to each selected individual web page from the identified web pages.

5. The method for archiving data stored in a plurality of linked web pages of claim 1 in which making a list of web pages to be archived comprises adding a second identifier to selected groups of individual web pages from the identified web pages.

6. The method for archiving data stored in a plurality of linked web pages of claim 3 in which selecting individual web pages from the identified web pages comprises presenting a list of identified web pages to a user and receiving an indication from the user to include or exclude each identified web page from the list of web pages to be archived.

7. The method for archiving data stored in a plurality of linked web pages of claim 1 further comprising the step of storing the visually perceptible archival copy of each web page in a durable, human readable medium.

8. The method for archiving data stored in a plurality of linked web pages of claim 7 further comprising the step of retrieving a digital image from the visually perceptible archival copy of each web page.

9. A website digital archiver for archiving data stored in a plurality of linked web pages, comprising:
software that comprises steps of:
traversing the plurality of web pages by recursively following the links to identify each of the individual web pages to be archived;
making a list of web pages to be archived;
sequentially retrieving the contents of each web page on the list; and
forming a digital image of the visible content of each web page.

10. A website digital archiver for archiving data stored in a plurality of linked web pages of claim 9 further comprising a CD writer that allows the user to write the image on a CD for short term storage.

11. A website digital archiver for archiving data stored in a plurality of linked web pages of claim 9 further comprising a microfilm writer that allow the user to write electronic images.

12. A website digital archiver for archiving data stored in a plurality of linked web pages of claim 10 further wherein the microfilm writer is a microfiche writer.

13. A website digital archiver for archiving data stored in a plurality of linked web pages of claim 12 in which the electronic file is a TIFF file.

14. A website digital archiver for archiving data stored in a plurality of linked web pages, of claim 12 further comprising a storage writer to create the electronic file to a visually perceptible archival copy of each web page from the digital image for archival storage.

15. A website digital archiver for archiving data stored in a plurality of linked web pages of claim 14 in which the storage is on a durable, human readable medium such as microfilm.

16. A website digital archiver for archiving data stored in a plurality of linked web pages of claim 15, further comprising a reader to retrieve a digital image from the visually perceptible archival copy of each web page on the durable, human readable medium.

17. A website digital archiver for archiving data stored in a plurality of linked web pages of claim 16 in which the digital image is a TIFF file.
